(19) United States
(12) Patent Application Publication
(10) Pub. No.: US 2017/0086430 A1
(43) Pub. Date: Mar. 30, 2017

(54) ALTERNATING ANGLE CONTROLLED WAVELENGTH LIGHTING SYSTEM TO STIMULATE FEEDING IN LARVAL FISH

(71) Applicant: Florida Atlantic University, Boca Raton, FL (US)

(72) Inventors: Paul S. Wills, Vero Beach, FL (US); Martin Riche, Fort Pierce, FL (US); Bing Ouyang, Vero Beach, FL (US)

(21) Appl. No.: 15/277,737

(22) Filed: Sep. 27, 2016

Related U.S. Application Data
(60) Provisional application No. 62/233,676, filed on Sep. 28, 2015.

(51) Int. Cl. A01K 61/02; A01K 63/06; F21V 21/26; F21V 21/088; F21V 23/04; F21V 31/00

(52) U.S. Cl. CPC A01K 61/025; F21V 23/0407; F21V 31/00; F21V 21/26; F21V 21/088; A01K 63/06; F21W 2131/308

(57) ABSTRACT

A method for feeding larval fish in an artificial habitat having a water level, includes the step of providing in the habitat a plurality of light sources at a plurality of three dimensional locations in the habitat and below the water level. Inanimate food particles are placed into the water. The plurality of lights are pulsed at the plurality of three dimensional locations intermittently to illuminate the food particles from a variety of different angles within the habitat. A system for feeding fish, a habitat for fish, and a larval fish food are also disclosed.

### CROSS-REFERENCE TO RELATED APPLICATION

This Application claims priority to U.S. Provisional Application No. 62/233,676, filed Sep. 28, 2015, entitled “ALTERNATING ANGLE CONTROLLED WAVELENGTH LED STROBE LIGHTING SYSTEM TO STIMULATE FEEDING IN LARVAL FISH”, the entirety of which is incorporated herein by reference.

### FIELD OF THE INVENTION

The present invention relates to larval fish production systems and methods.

### BACKGROUND OF THE INVENTION

Marine larval fish are poorly developed at first hatch and it is during the embryonic and larval stages that all organs and biological systems develop. These critical life stages, therefore, establish the basis for much of a fish's performance in later stages: an estimated 90% of its future plasticity and performance potential are set at this time. During the transition from endogenous to exogenous feeding, marine fish are difficult to habituate to a prepared pelleted diet, and so they must be provided a live food item, for example rotifers or Artemia, for the initial weeks of growth. Currently, contrasting agents such as algae or clay suspensions are used to improve visual response and prey capture. Both live feeds and algae represent substantial costs in supplies and labor. Live feeds are nutritionally incomplete, so the fish require artificial nutritional enrichment of these live feeds, which is expensive and labor-intensive. The result is high production costs for seed stock. Innovative methods for reducing or eliminating the need for live feeds and contrast agents will be transformative to this rapidly developing agricultural sector.

It has been asserted, and appears to be the case, that movement of feed items is required to stimulate larval fish feeding. In addition, prey (feed) detection requires visual contrast between the prey and background, which depends on the optical properties of the prey item, background, and environment. Furthermore, the ability to distinguish colors (spectral sensitivity) plays an integral part in framing the contrast between a prey item and turbidity created by microalgae in green-water culture, and the larvae's ability to successfully forage.

### SUMMARY OF THE INVENTION

A method for feeding fish in an artificial habitat having a water level, includes the step of providing in the habitat a plurality of light sources at a plurality of three dimensional locations in the habitat and below the water level. Inanimate food particles are placed into the water. The plurality of lights are pulsed at the plurality of three dimensional locations intermittently to illuminate the food particles from a variety of different angles within the habitat.

The light can include both the visible and ultraviolet light spectrum or can be exclusively ultraviolet light. The method can further include the step of providing in the food particles food components with fluorochromic characteristics, the fluorochrome being excited at the wavelength of the ultraviolet light.

The oscillation period of the light pulses can be from 1/16^{th} sec to 2 sec. The pulse intensity of each of the lights can be from 0.1 w to 2 w. The number of lights can be from 2 to 12. The spacing of the lights can be from 30 degrees to 180 degrees apart.

The positioning of the lights can be underwater, and wherein the pulse pattern can be circumferential around the perimeter of the habitat. The lights can be provided on detachable supports. The fish can be marine or freshwater larval fish. The light can be radially directed relative to a center of the habitat.

The lighting pattern can be cyclic and the cycle period can be determined according to the formula:

$$T = \frac{2 d}{v}$$

where T is the period in seconds to illuminate all positions of the array, d is the diameter of the food particle being illuminated (mm), and v is the linear swimming velocity of the live food animal being simulated (mm/second).

The duration of each illumination position in the array can be determined by the formula:

$$D = \frac{T}{L}$$

where, D is the duration of illumination of each illumination position of the array (seconds), T is the period to cycle through each illuminated position in the (seconds/cycle), and L is the number of illuminated positions in the array.

A system for feeding fish with inanimate food particles in a habitat, includes a plurality of light sources for placement at a plurality of three dimensional locations in the habitat and below the water level. A connection can be provided for powering the light sources. A controller can be provided for pulsing the plurality of lights at the plurality of three dimensional locations intermittently to illuminate the food particles from a variety of different angles within the habitat.

The controller can be a processor programmed to pulse each of the plurality of lights independently. The light sources can be ultraviolet light sources. The light sources can be ultraviolet A light sources. The habitat can be an artificial habitat.

The system can further include an inanimate fish food, The fish food can be provided as particles and can include at least one fluorescing component and at least one nutritional component.

A habitat for fish can include a water containment habitat having a bottom and sides and a water level. A plurality of light sources can be located in a variety of different positions at the sides of the habitat and below the water level. A connection is provided for powering the light sources. A controller is provided pulsing the plurality of lights at the plurality of three dimensional locations intermittently to illuminate inanimate food particles from a variety of different angles within the habitat.

A food for larval fish can include particles of at least one nutritional component and at least one other fluorescing food component. The fluorescing food component fluoresces under the application of ultraviolet light. The fluorescing food component can include at least one selected from the group consisting of polyphenolic flavonoids, porphyrins, indole containing compounds, chlorophyllin, chlorophyll, and Echinacea. The food can include naturally occurring pigments which can also be incorporated into the feed. The fluorescing components can include in whole or in part organisms that include but not limited to micro and macroalgae, fungi, protisits, bacteria, probiotics, prebiotics, cyanobacteria, insects, flowering plants, marine invertebrates, and other natural and synthetic dyes. The fluorescing component can be riboflavin.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic perspective view of a system and method according to the invention.

FIG. 2A-2E are schematic plan (top), perspective (middle) and magnified perspective (bottom) views illustrating a method according to the invention in first (FIG. 2A); second (FIG. 2B); third (FIG. 2C); fourth (FIG. 2D); and fifth (FIG. 2E) modes of operation.

FIG. 3A-3E are schematic depictions of a method according to the invention in first (FIG. 3A); second (FIG. 3B); third (FIG. 3C); fourth (FIG. 3D); and fifth (FIG. 3E) modes of operation.

FIG. 4 is a schematic plan (top), perspective (middle), and magnified perspective (bottom) views of an alternative mode of operation.

FIG. 5 is a schematic front and rear perspective view of a lighting assembly according to the invention.

FIG. 6 is a schematic diagram illustrating a lighting assembly and method of making a lighting assembly.

FIG. 7 is a schematic diagram of a control system for a system and method according to the invention.

FIG. 8 is a schematic perspective view of an alternative lighting component according to invention.

FIG. 9 is a schematic diagram of an alternative lighting system.

FIG. 10 is a schematic diagram of an alternative lighting system in a first mode of operation (left) and a second mode of operation (right).

### DETAILED DESCRIPTION OF THE INVENTION

A method for feeding fish in an artificial habitat having a water level includes the steps of providing in the habitat a plurality of light sources at a plurality of three dimensional locations in the habitat and below the water level. Inanimate food particles are placed into the water. The plurality of lights are pulsed at the plurality of three dimensional locations intermittently to illuminate the food particles from a variety of different angles within the habitat. The systems and methods of the invention have broad applicability to a wide variety of fish species in both freshwater and marine environments. The invention is particularly suitable for larval fish.

The pattern of light can vary. The lighting pattern parameters include, but are not limited to light location, angle, wavelength, intensity, pulse duration, pulse frequency and pulse shape (ramping). The lighting pattern that is necessary to stimulate feeding on inanimate food can vary depending on the species of fish. The pattern of light can be selected to mimic the speed and motion of a natural animate food source for the fish, or the pattern can be developed empirically based upon patterns found to stimulate feeding of the fish on the inanimate food. It is only necessary that the direction from which the light emanates within the habitat varies with time, and that the light from any particular source within the habitat is intermittent. The light sources, such as light emitting diode (LED) lights, can be distributed across three dimensional space within the habitat to insure that different levels of the habitat are illuminated, as the larval fish will generally be located at many different levels within the water column of the habitat. The process for determining a lighting pattern for a species can be a combination of empirical studies with that species, observing and mimicking movement patterns of live food consumed by the species, combined with efforts focusing on patterns that have been successful on related species.

The pulsing of the lights within the habitat can vary. The light sources can be distributed circumferentially around the habitat. The light sources can be sequentially pulsed in a clockwise or counterclockwise pattern. The pattern can be one without overlap, such that circumferentially distributed sources are not on at the same time, or some small amount of pulse overlap between light sources is possible. The light sources can also be pulsed in a random pattern created by a processor. A continuous source of light such as a light tube can be provided in each circumferential position, or a plurality of vertically spaced apart light sources can be provided. Multiple light sources at a given circumferential location but at different depths in the habitat can be activated at the same time, or individually controlled so that not only circumferential light source pulsing variance is possible, but also vertically differentiated light sources can be pulsed. Light sources can be circumferentially and vertically distributed in any number and pattern within the habitat, at the walls of the habitat or within the habitat. A bank of light sources can be vertically aligned at each circumferential lighting positions, such that a column of lights is activated at the same time.

The pulse duration can vary. A pulse of light can be followed immediately by another pulse from another light source, or successive pulses can be separated by a period of time in which no source is pulsed. The pulse intensity should be sufficient to traverse the dimension of the habitat in the direction of light travel and provide sufficient illumination of the inanimate food such that the species of fish will be stimulated to feed. This will vary according to the fish, the habitat, the food, and the water conditions such as turbidity. The intensity of the light can be a step function, essentially “on/off” or the intensity of a pulse can be ramped up and ramped down from the point of maximum intensity. The ramp duration can vary, and in one aspect can be up to about 20% of the total pulse duration. The ramp duration up and down can be equal, for example 10% and 10% of pulse duration, or can be different, for example 5% and 15%.

The number of lights within the habitat can also vary. Four different light sources can provide sufficient illumination from a variety of angles within the habitat if circumferentially distributed. More or fewer light sources are possible. The spacing of the lights can be ordered or random, but is preferably ordered in an equally spaced or geometric pattern such that light source pulsing can be more easily programmed.

The oscillation period of the light pulses can be from 1/16^{th} sec to 2 sec. Other oscillation periods are possible. The pulse intensity of each of the lights can be from 0.1 w to 2 w. Other pulse intensities are possible, depending on the tank size. The number of lights can be from 2 to 12. Other numbers of lights or light arrays are possible. The spacing of the lights can be from 30 degrees to 180 degrees apart. Other light spacing is possible.

The direction of the light within the habitat can vary. The light can travel horizontally through the habitat or can be partially angled from the horizontal. The light can travel diagonally across the habitat, through an approximate center, or can travel in other off-of-center directions through the habitat. The light can be radially directed relative to a center of the habitat, and travel from the sides of the habitat inward, or radially outward from a central lighting position in the habitat.

The lighting pattern can be adjusted to mimic an animate source of live food for the species of fish. In order to simulate the speed of a live food animal with a known swimming speed the period of rotation through all of the illuminated positions of the light array, and the amount of time each illuminated position is on, can be calculated. This can be accomplished with two equations:

$$T = \frac{2 d}{v} \qquad ( eq . 1 )$$

where,
T=period necessary to illuminate all positions of the array—the time in seconds required to cycle through each illuminated position in the two dimensional circular array (seconds/cycle)
d=diameter of the food particle being illuminated (mm)
v=linear swimming velocity of the live food animal being simulated (mm/second)

and,

$$D = \frac{T}{L} \qquad ( eq . 2 )$$

where,
D=duration of illumination of each illumination position of the array (seconds)
L=number of illuminated positions in the array (seconds)

Examples of the application of these equations are as follows:

### EXAMPLE 1

Assume the illuminated array has 4 positions, the live food item is a rotifer (e.g., Brachionus rotundiformis) that moves with a linear velocity of approximately 0.40 mm/s, and the prepared food particle is 0.10 mm in diameter. In this first example T=(2×0.10)/0.04=0.50 seconds (see eq. 1) and D=0.5/4=0.125 seconds (see eq. 2). Each illuminated position would turn on at 0.125 second intervals (⅛^{th} of a second intervals).

### EXAMPLE 2

If the particle diameter was twice as large (0.20 mm) then T=2×0.20)/0.40=1 second (see eq. 1) and D=¼=0.25 seconds (¼th second intervals) (see eq. 2).

### EXAMPLE 3

If the array had six positions and the particle was 0.1 mm (see Example 1, T=0.5 seconds) then D=0.5/6 or 0.083 seconds ( 1/12^{th} second intervals) (see eq. 2).

The invention provides a lighting pattern generation system to enhance visual contrast and simulate feed movement to marine larval fish. The enhanced food recognition will stimulate feed intake, growth, and development. The wavelengths of light that are used to stimulate feeding can vary. Different species of fish can be responsive to different wavelengths or groups of wavelengths such as visible or ultraviolet light. However, recent advances in understanding fish UV vision have led to insight into UV light and foraging behavior. It has been shown that environmental UV light can provide visual contrast for predators possessing UV vision by silhouetting nearby prey against a bright, UV-illuminated background. The developing eye of most marine larval fish has long-wavelength UV (UV-A) receptors utilized for prey capture. However, this part of the electromagnetic spectrum is missing from the standard lighting systems in fish hatcheries. Although many larval fish utilize the UV spectrum, with some losing the ability in later life stages, not all species are sensitive to UV light. Oscillation between selected frequencies of light is possible.

The light can comprise ultraviolet light for those species that have visual acuity for ultraviolet light. Ultraviolet light can be used for some species to generate lighting patterns that improve feed contrast and simulate movement of food items to enhance visual response and feed intake of larval fishes. For example, the visual sensitivity of red porgy, Pagrus pagrus, to UV can lead to an identified combined intensity and wavelength that is preferable. Other marine species might exhibit UV vision as well. Such relationships can be used as first approximations for appropriate lighting patterns. If the fish species being cultured do not show the visual sensitivity necessary to render a significant relationship to increased feed intake, the lighting design and pattern will be changed. The generated oscillation patterns should be validated as stimulating growth and ontogenic development in the species of larval marine fish. The use of ultraviolet light has the added advantage of being useful to control the growth of certain algae and other organisms in the habitat that either do not grow in ultraviolet light or where ultraviolet light is harmful to the organism.

A variety of ultraviolet wavelengths are possible. UV wavelengths in the range of 315-400 nm (A peak=360 nm) also known as UV-A, long-wave, or black-light are preferred for being both effective and comparatively safe relative to shorter ultraviolet wavelengths. The lens of the human eye blocks these frequencies. UV-A has less photobiological activity than either UV-B (280-315 nm) or UV-C (180-280 nm) and thus is of low risk due to exposure. Most adverse effects of UV exposure are attributable to UV-B and UV-C. The intensity of UV-A illumination that is necessary to generate effective irradiance levels is well below the limits considered hazardous during a given work period (8 hours). Regardless, it is desirable to shield workers such as by covering the tank habitats with opaque plastic and turning off lighting for routine husbandry tasks such as tank cleaning to reduce the probability of incidental exposure.
Incorporation of ingredients in a microparticulate diet that fluoresce at visible wavelengths when illuminated by UV would also result in visual stimulation for larval fish. Fluorescing food components, the food components fluorescing at a given wavelength due to the wavelength of the ultraviolet light, are known. For example, riboflavin (Vitamin B2) exhibits chartreuse fluorescence. Other fluorochromic substances such as the polyphenolic flavonoids, porphyrins, indole containing compounds, chlorophyllin, chlorophyll, echinacea, and other naturally occurring pigments can also be incorporated into the feed. The fluorescing components can include in whole or in part organisms that include but not limited to micro and macroalgae, fungi, protisits, bacteria, probiotics, prebiotics, cyanobacteria, insects, flowering plants, marine invertebrates, and other natural and synthetic dyes. These components can have the additional benefit of providing some nutrition to the fish. Such compounds should of course be non-toxic to the species and should result in the appropriate excitation and emission spectra for the application, and should fluoresce at a wavelength that is both visible to the fish and stimulative of feeding. These compounds do not necessarily need to be nutritious but that would impart a secondary advantage.

The fluorescing compound can be combined with the food in varying proportions. Foods for fish and particularly larval fish can vary depending on the species. Various combinations of protein, carbohydrates, fats and vitamins are used depending on the species of fish being grown. Similarly, the amount of fluorescing compound that is necessary can vary depending on the species and other factors such as the wavelength and intensity of the light and the size of the habitat and the turbidity of the water. The amount of fluorescing compound can exceed that of any fluorescing compound that might naturally be present in the food source. Such enhanced levels of fluorescing compound will stimulate feeding under the appropriate oscillating pattern and period.

A system for feeding fish with inanimate food particles in a habitat, includes a plurality of light sources for placement at a plurality of three dimensional locations in the habitat and below the water level. A connection is provided for powering the light sources. A controller pulses the plurality of lights at the plurality of three dimensional locations intermittently to illuminate the food particles from a variety of different angles within the habitat.

The light sources can be of any suitable construction. Light emitting diode (LED) light sources provide good light generation, are durable, energy efficient, and relatively low in cost. LED lights also can be constructed to be individually and wirelessly controllable. LEDs are efficient and are tunable to narrow and specific bandwidths, and LEDs are readily available that emit at a variety of different light wavelengths, including visible, ultraviolet, and selected portions thereof. Other lighting systems such as fluorescent, halogen, incandescent, and others are possible.

The light sources can be permanently affixed to the habitat. The light sources can alternatively be provided on supports which can be removably attached to the habitat or otherwise positioned in the habitat.

After lighting oscillation frequencies and patterns have been identified that enhance larval feeding for the species, an array and controller system can be programmed that provides variable oscillation periods, and tuning of the light's spectrum and/or intensity. The lighting pattern can be stored and communicated to the controller system and array by a suitable computer, which can communicate with the controller and array wirelessly or through a wired connection.

The habitat can be of any suitable construction. Suitable habitats are well known in the art and the invention can be utilized with any such habitats. The invention can be used for enclosed tank habitats, for artificial ponds, and for cage habitats in natural ocean, river or lake environments. The invention can also be used in habitats of varying shapes and dimensions.

The invention provides an integrated system of watertight lighting for larval fish tanks wherein light is provided from two or more incident angles while being flashed in a synchronized manner to simulate movement in inanimate feed particles stimulating a feeding response similar to that seen when providing a live food item (i.e., prey). This lighting system may incorporate lights with output wavelengths that differ from pure white light and are optimized to provide additional stimulation of the feeding response.

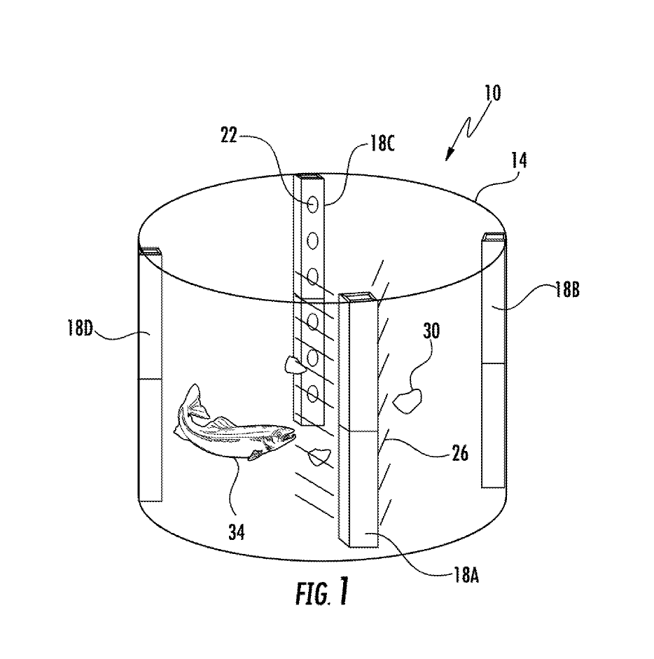

FIG. 1 is a schematic perspective view of a system 10 and method according to the invention. The system 10 can include a habitat 14 that has disposed therein a plurality of LED lighting fixtures 18A-18D. More or fewer light fixtures are possible and can be positioned in other locations in the habitat 14. The light fixtures 18 have a plurality of lights 22. The lights 22 are operated according to a controller such that the lights 22 of each fixture 18A-D can be pulsed according to a predetermined program. It will be appreciated that the lights 22 can be individually connected and programmed to independently control each LED light fixture 22 in the habitat 14 to emit light pulses 26. The food particles 30 are distributed in the habitat and are impacted by the light pulses 26 so as to stimulate feeding of the fish 34.

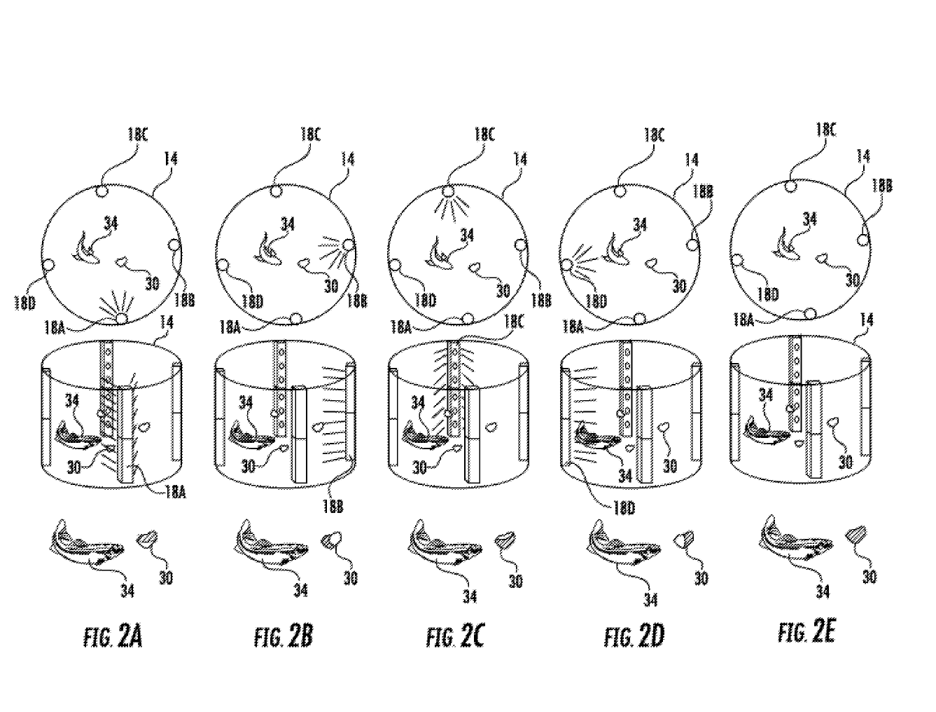

FIG. 2A-2E are schematic plan (top), perspective (middle) and magnified perspective (bottom) views illustrating a method according to the invention. In a first step (FIG. 2A) the fixture 18A is pulsed and illuminates the particle 30 which is seen by the fish 34 as partially illuminated. In a second step (FIG. 2B) the light pulse has cycled to fixture 18B such that the light pulse illuminates a side of the particle 30 opposite the fish 34 and the side of the particle 30 facing the fish is shaded. In a third step (FIG. 2C) the light pulse has cycled to fixture 18C and the fish 34 sees a particle 30 which is half shaded, half not. A fourth step (FIG. 2D) pulses the light fixture 18D and the side of the particle 30 facing the fish is fully illuminated. In a fifth step (FIG. 2E) all fixtures 18A-D are not pulsed and the particle 30 is completely shaded. The effect of this cycling of the lighting is a strobe effect in which the particle 30 appears to move and stimulates feeding of the fish.

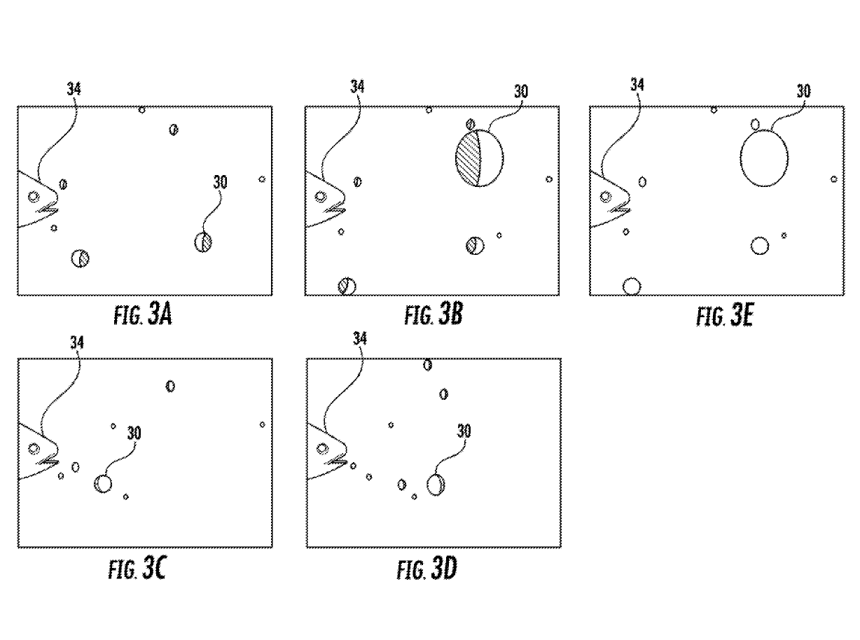

FIG. 3A-3E are schematic depictions of food particles 30 in the fish 34 as lighting in the habitat is cycled. As shown, the lighting on the food particles 30 changes as the various lights in the habitat are pulsed. This creates an illusion of movement which is stimulative to the feeding of the larval fish as a result of its innate striking response.

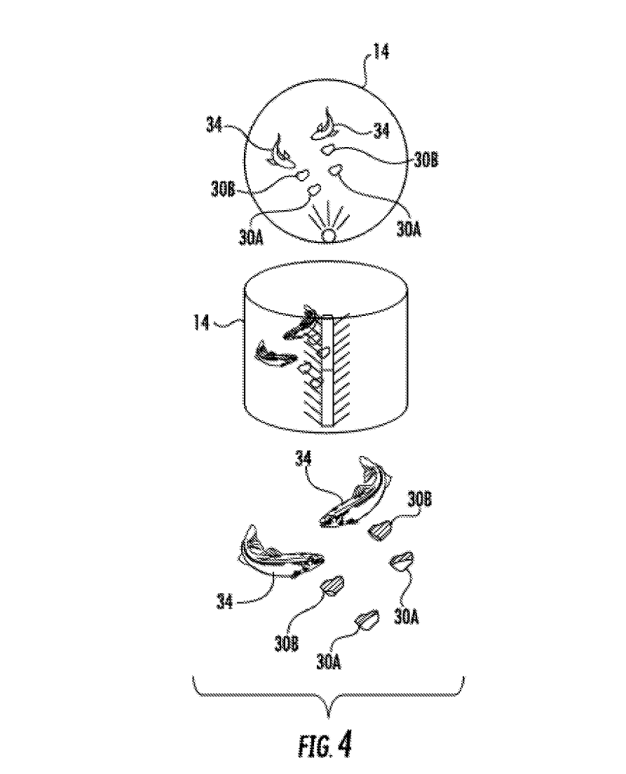

FIG. 4 is a schematic plan (top), perspective (middle), and magnified perspective (bottom) views of an alternative mode of operation illustrating how particle-particle shading can assist in the process. The particles 30A are closest to the light source that is being pulsed. The particles 30B are interposed between the particles 30A and the fish 34. The particles 30B are partially shaded by the particles 30A. This particle-particle shading is repeated with different particle pairs as the lights are pulsed around the habitat 14. The particle-particle shading creates an additional illusion of movement as the lights around the habitat are pulsed and is stimulative of feeding.

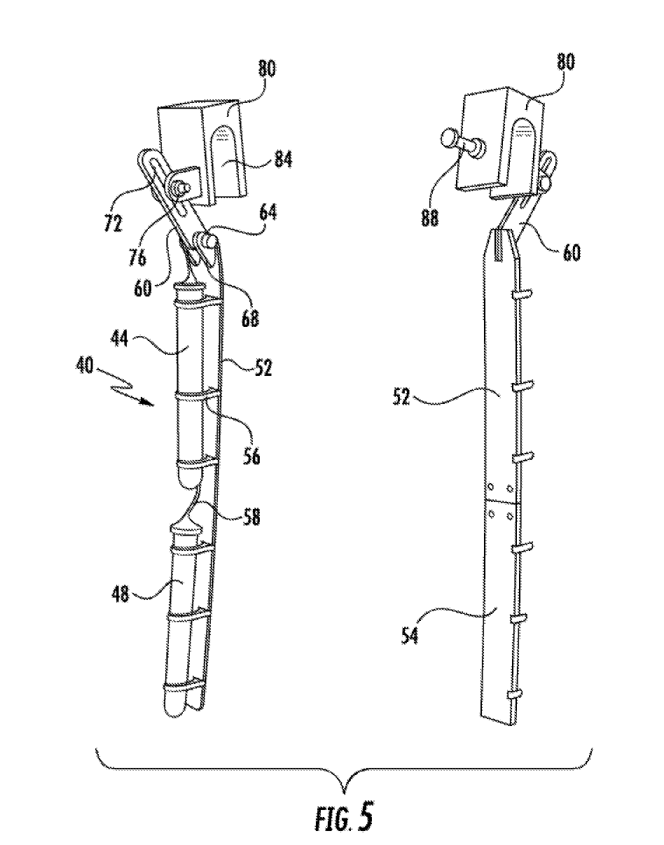

The light can be incorporated into the habitat by many different systems and methods. For example, specialized habitats can be constructed where the lights are permanently incorporated into the walls of the habitat. A less-expensive and portable solution is to provide controllable lighting on portable mounts. FIG. 5 is a schematic front (left) and rear (right) perspective view of a lighting assembly 40 according to the invention. The lighting assembly 40 has upper lights 44 and lower lights 48. Any number of lights is possible. The lights 44 and 48 are mounted to an upper mount 52 and lower mount 54, although any suitable mount construction is possible. Fasteners 56 can be provided to secure the lights to the mounts 52 and 54. Wiring 58 supplies controllable power to the lights 44 and 48. The assembly 40 can include a pivot arm 60 which can be pivotally mounted to a pivot pin 64 that is secured to supports 68. The pivot arm 60 can have a slot 72 which can receive a bolt 76 which can be tightened by suitable structure such as a nut to allow vertical adjustment within the habitat. A clamp 80 has a groove 84 for placement on an upper edge of the habitat. A set screw 88 can be used to secure the clamp 80 in place.

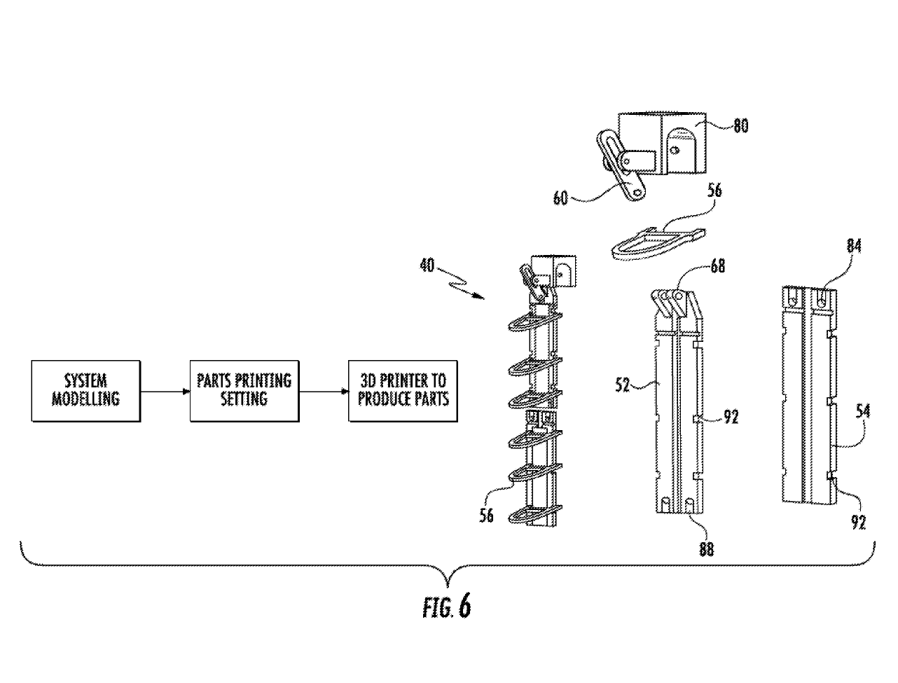

FIG. 6 is a schematic diagram illustrating a lighting assembly and method of making a lighting assembly. The entire lighting assembly 40 can be custom made by such processes as additive manufacturing. The process begins with system modeling, proceeds with part printing settings, and then proceeds to the additive printing process. The lights themselves are provided separately and secured by the fasteners 56 however it is possible in the future that the lights themselves could be printed.

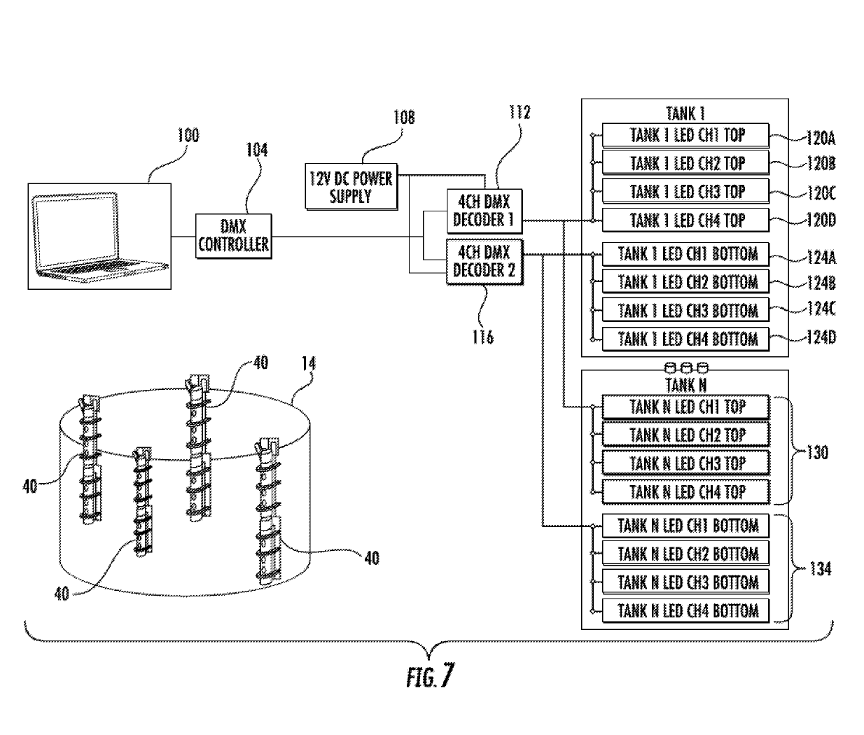

FIG. 7 is a schematic diagram of a control system for a system and method according to the invention. The system includes a processor such as computer 100 and a suitable controller 104 which receives instructions from the computer 100 and translates these instructions into control signals for the system. A suitable power supply such as the DC power supply 108 provides power to the system. DMX decoders such as the four channel decoder 112 and a second decoder 116 can be provided to control top channel lights 120A-D and bottom channel lights 124A-D of the lighting assemblies 40 in habitat 14. It will be appreciated that suitable software and control systems can be provided to control the lights in any desired fashion, including individually. The system is expandable to any number of tanks or habitats, such as with top channel lights 130 and bottom channel lights 134 for tank N except as may be limited by the power output of the DMX decoder and the DC power supply.

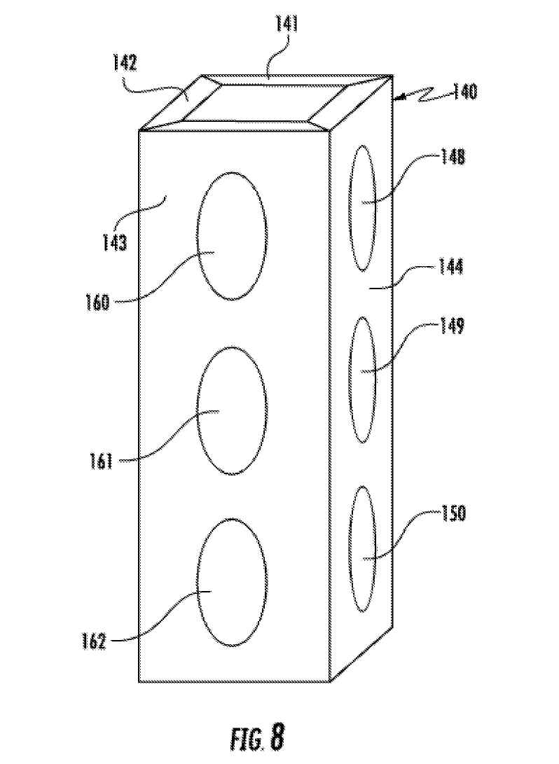

The lights can be placed in any suitable location within the habitat so long as the source location of the lights provides good coverage of the water in the habitat as the lights are cycled. There is shown in FIG. 8 a schematic perspective view of an alternative lighting component 140 according to invention which is adapted to be placed at or near the center of the tank and radiate light radially outward, as compared to radially inward from the sides of the tank as previously described. The embodiment shown in FIG. 8 has four sides 141-144, although more or fewer sides are possible. Each side is shown with three lights (top, middle, bottom) although more or fewer lights are possible. Side 143 is shown with top light 160, middle light 161, and bottom light 162. Side 144 is shown with top light 148, middle light 149, bottom light 150. These lights can be controlled so as to illuminate all of the lights in a side at the same time, for example lights 148-150 of side 144, or individually such that variation and pulsing of the lights around the habitat as well as up and down in the water column is possible and controllable.

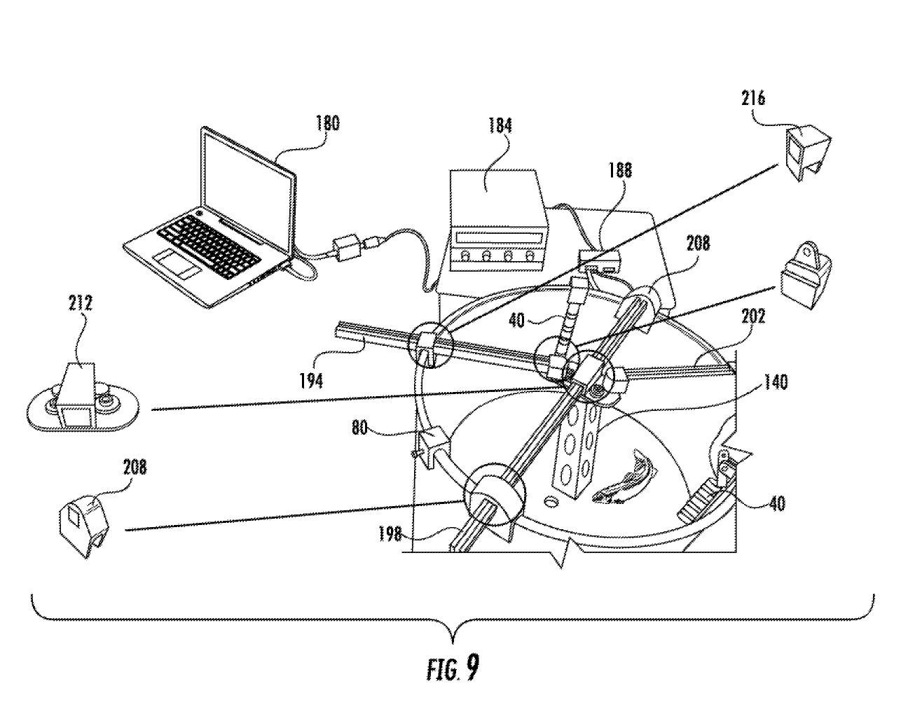

There is shown in FIG. 9 a system incorporating the alternative lighting component 140. A processor or computer 180 can provide signals to a controller 184 and DMX decoder 188. Support arms 194, 198 and 202 can be provided to suspend the lighting component 140 in the habitat and below the water level. Clamps 208 and 216 can be provided to adjustably secure the support arms to the habitat. The lighting component 140 can be suspended from a support 212 that is slidable on the support arm 198 to provide for adjustment of the position of the lighting component 140 within the habitat. Side wall mounted lighting assemblies 40 can also be mounted to the habitat by clamps 80 as previously described, if desired.

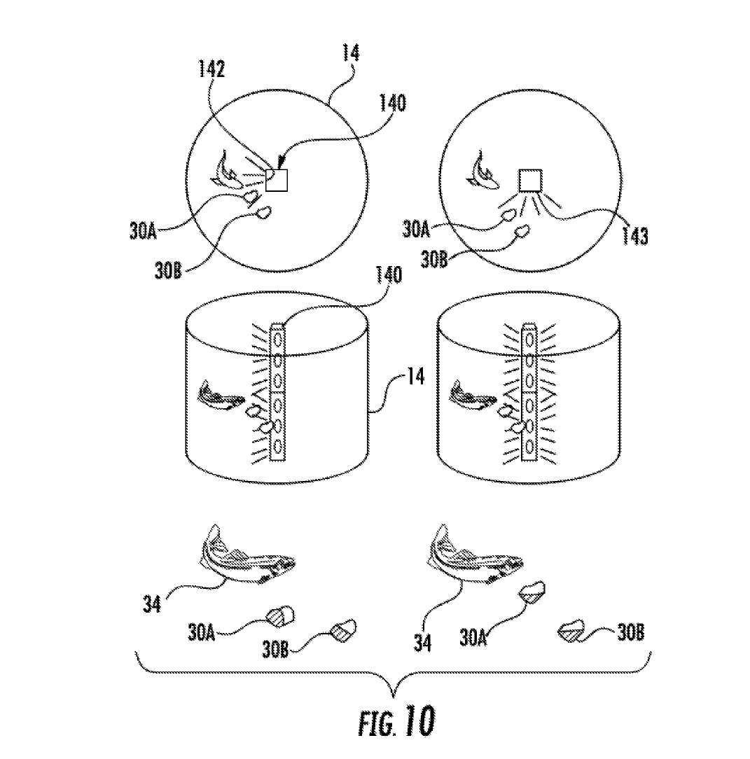

FIG. 10 is a schematic diagram of the alternative lighting system in a first mode of operation (left) and a second mode of operation (right). As can be seen from the left-hand drawing, light emanates from the side 142 such that left-hand side of the particles 30 A and 30 B are shaded. As the lighting is pulsed from the side 142 (left-hand side) to the side 143 (right-hand side) the shading on the particles 30 A and 30 B will change as indicated. The movement of light across the surface of the particle will simulate particle movement and stimulate feed uptake.

The invention in determining appropriate lighting patterns requires four steps:

Step 1. Measure movement patterns of rotifers Brachionus sp. using a microscope digital camera system to determine an initial oscillation period to stimulate feed intake. Step 2. Design a UV-LED lighting array and controller system that provides variable oscillation periods. Step 3. Conduct a range-finding test using larval fish such as red porgies Pagrus pagrus as a model to identify the range of frequencies stimulating increased feed intake. Steady warm white LED can serve as the control. The oscillation period determined under step 1 will serve as the range median, with four periods above and four below the median determined by arithmetic progression. Step 4. Conduct a replicated study with warm white LED as the control and a narrower range of three periods, each treatment with six replicates, to optimize the method for the species of interest.

Rotifers Brachionus sp. can be cultured and observed under magnification using a Stereomicroscope fitted with a Microscope Digital Camera system linked to a PC running Microscope Imaging Software for image acquisition and analysis. This microscope package allows for real-time and time-lapse images and movies to be stored and processed. Total distance of movement on the curvilinear swimming path of up to 100 rotifers in four separate samples at three or more temperatures (for example 15, 20, and 25° C.) can be measured and parsed with the time period of image acquisition to determine the temperature-related velocity. This velocity can be translated to an oscillation period by determining the linear timing of the illumination across the face of a food particle based on the particle dimensions using equations 1 and 2.

The lighting arrays can be fabricated using off-the-shelf UV-LED strip lighting that emits UV such as with a peak emittance at λₚₑₐₖ=360 nm. A controller such as a MATRIX DMX 4 Channel Relay Double Output DMX Dimmer Pack, or equivalent, can be used to provide cost-effective control of oscillation period for the sequential illumination of the four discrete illuminator positions of the array. The dimmer pack enables 16 individual programs of varying frequency and intensity (intensity variation will be evaluated pending leveraged funding), and each channel can support 600 W output. All of the tanks fitted with UV-LED arrays can be simultaneously controlled from a single DMX Dimmer pack, and each of the four UV-LED illuminators in each tank can be controlled by one of the four Dimmer Pack channels. Each illuminator can be packaged inside a Corning® Pyrex® 7740 borosilicate test tube. This type of glass transmits >90% of UV-A emitted by the UV-LEDs. The tubes can be “potted” at the top opening to create a water tight package that allows the electrical leads of the LEDs to pass unhindered to the control system. White light (2700-3500K) LEDs will be used to provide “warm white light” illumination for the control. The white light LEDs can be packaged in borosilicate glass tubes and mounted in a manner consistent with the UV-LED array tubes.

The periodicity of oscillation can be determined by a translation of linear velocity of rotifers or other feed organisms into a linear speed of travel of the illumination across the face of a food particle, which enables equilibration of linear velocity to duration between lighting of each UV-LED emitter in the array since every other emitter will light opposite sides of a given particle. Regression analyses of response (i.e., growth and survival) relative to oscillation period can be conducted to determine the response-frequency relationship (e.g., peak response period).

The invention has many applications. One application includes providing functionality in improving survival, growth, and feed intake in marine larval fish fed formulated microparticulate diets. Early transition to microparticulate diets will allow determining nutrient requirements of larval fish, which remains relatively unexplored due to the inability to get larval fish to accept suitable experimental diets. Extensions of these results include applications to other fish species and life stages.

Production of larval fish is one of the primary constraints to development of marine fish culture. This is particularly true for emerging candidate species, for which there is little technical information to foster reliable juvenile production. Techniques for production of more established species such as Salmonids and catfish are not directly transferable. The invention has broad application to improve efficiency and reduce costs in the production of a variety of marine and freshwater species that currently require live prey at the onset of exogenous feeding. The invention provides for the development of new and improved animal husbandry and production systems that take into account production efficiency, animal well-being, and animal systems applicable to aquaculture.

The invention provides a system for larval fish production (i.e., animal husbandry and production systems) that has the potential to reduce material costs and labor needed to produce healthy, high-quality seed stock, with broad application to a variety of marine and freshwater fish production systems.

This invention can be embodied in other forms without departing from the spirit or essential attributes thereof, and accordingly reference should be made to the following claims to determine the scope of the invention.

We claim:

1. A method for feeding fish in an artificial habitat having a water level, comprising the steps of:
providing in the habitat a plurality of light sources at a plurality of three dimensional locations in the habitat and below the water level;
placing inanimate food particles into the water;
pulsing the plurality of lights at the plurality of three dimensional locations intermittently to illuminate the food particles from a variety of different angles within the habitat.

2. The method of claim 1, wherein the light comprises ultraviolet light.

3. The method of claim 2, further comprising the step of providing in the food particles food components with fluorochromic characteristics, the fluorochrome being excited at the wavelength of the ultraviolet light.

4. The method of claim 1, wherein the oscillation period of the light pulses is from 1/16^{th} sec to 2 sec.

5. The method of claim 1, wherein the pulse intensity of each of the lights is from 0.1 w to 2 w

6. The method of claim 1, wherein the number of lights is from 2 to 12.

7. The method of claim 1, wherein the spacing of the lights is from 30 degrees to 180 degrees apart.

8. The method of claim 1, wherein the positioning of the lights is underwater.

9. The method of claim 1, wherein the pulse pattern is circumferential around the perimeter of the habitat.

10. The method of claim 1, wherein the lights are provided on detachable supports.

11. The method of claim 1, wherein the fish are marine or freshwater larval fish.

12. The method of claim 1, wherein the light is radially directed relative to a center of the habitat.

13. The method of claim 1, wherein the lighting pattern is cyclic and the cycle period is determined according to the formula:
$$T = \frac{2 d}{v}$$
where T is the period in seconds to illuminate all positions of the array, d is the diameter of the food particle being illuminated (mm), and v is the linear swimming velocity of the live food animal being simulated (mm/second).

14. The method of claim 1, wherein the duration of each illumination position in the array is determined by the formula:
$$D = \frac{T}{L}$$
where, D is the duration of illumination of each illumination position of the array (seconds), T is the period to cycle through each illuminated position in the (seconds/cycle), and L is the number of illuminated positions in the array.

15. A system for feeding fish with inanimate food particles in a habitat, comprising:
a plurality of light sources for placement at a plurality of three dimensional locations in the habitat and below the water level;
a connection for powering the light sources;
a controller for pulsing the plurality of lights at the plurality of three dimensional locations intermittently to illuminate the food particles from a variety of different angles within the habitat.

16. The system of claim 15, wherein the controller is a processor programmed to pulse each of the plurality of lights independently.

17. The system of claim 15, wherein the light sources comprise ultraviolet light sources.

18. The system of claim 17, wherein the light sources comprise ultraviolet A light sources.

19. The system of claim 15, wherein the habitat is an artificial habitat.

20. The system of claim 15, further comprising an inanimate fish food, the fish food provided as particles and comprising at least one fluorescing component and at least one nutritional component.

21. A habitat for fish, comprising;
a water containment habitat having a bottom and sides and a water level;
a plurality of light sources located in a variety of different positions at the sides of the habitat and below the water level;
a connection for powering the light sources; and;
a controller for pulsing the plurality of lights at the plurality of three dimensional locations intermittently to illuminate inanimate food particles from a variety of different angles within the habitat.

22. A food for larval fish, comprising particles of at least one nutritional component and at least one other fluorescing food component, the fluorescing food component fluorescing under the application of ultraviolet light.

23. The food of claim 22, wherein the fluorescing food component comprises at least one selected from the group consisting of polyphenolic flavonoids, porphyrins, indole containing compounds, chlorophyllin, chlorophyll, echinacea, or other naturally occurring pigments which can also be incorporated into the feed.

24. The food of claim 22, wherein the fluorescing components comprise at least one selected from the group consisting of micro and macroalgae, fungi, protisits, bacteria, probiotics, prebiotics, cyanobacteria, insects, flowering plants, marine invertebrates, and other natural and synthetic dyes.

25. The food of claim 22, wherein the fluorescing component is riboflavin.
